(19) United States
(12) Patent Application Publication
(10) Pub. No.: US 2024/0391735 A1
(43) Pub. Date: Nov. 28, 2024

(54) ELEVATOR SEATING SYSTEM

(71) Applicant: OTIS ELEVATOR COMPANY, Farmington, CT (US)

(72) Inventors: Kiron Bhaskar, Farmington, CT (US); Randy Roberts, Hebron, CT (US)

(21) Appl. No.: 18/200,882

(22) Filed: May 23, 2023

(51) Int. Cl. B66B 5/02; B66B 1/28; B66B 1/34; B66B 3/00; B66B 9/00

(52) U.S. Cl. CPC B66B 5/02; B66B 1/28; B66B 1/3476; B66B 3/002; B66B 9/003

(57) ABSTRACT

A method and apparatus are provided for an elevator system that includes at least one elevator car including a floor and a plurality of walls, and at least one seat assembly supported on at least one of the plurality of walls or on the floor. A detector is configured to detect when a passenger is on the at least one seat assembly. A passenger retention member is configured to resist movement of a passenger relative to the at least one seat assembly. An indicator is configured to provide an indication regarding a condition of the passenger retention member when the detector detects a passenger on the at least one seat assembly.

### BACKGROUND

Elevator systems are in widespread use for carrying passengers between various levels in buildings, for example. Some elevator systems are traction-based and use a suspension assembly to suspend an elevator car and a counterweight. Other elevator systems are self-propelled, also referred to as ropeless elevator systems, which are useful in certain applications such as high-rise buildings. In one example, a self-propelled elevator system has a first hoistway designated for upward traveling elevator cars and a second hoistway designated for downward traveling elevator cars. A transfer station at each end of the hoistway is used to move cars horizontally between the first and second hoistways. For elevators that can have both horizontal and vertical movements, passenger comfort should be considered.

### SUMMARY

An illustrative example embodiment of an elevator system includes: at least one elevator car including a floor and a plurality of walls; at least one seat assembly supported on at least one of the plurality of walls or on the floor; a detector configured to detect when a passenger is on the at least one seat assembly; a passenger retention member that is configured to resist movement of a passenger relative to the at least one seat assembly; and an indicator configured to provide an indication regarding a condition of the passenger retention member when the detector detects a passenger on the at least one seat assembly.

In addition to one or more of the features described above, or as an alternative, the system includes a controller that is configured to selectively allow the at least one elevator car to move based on the indication satisfying at least one criterion when the detector detects a passenger on the at least one seat assembly.

In addition to one or more of the features described above, or as an alternative, the controller is configured to: prevent the elevator car from moving when the detector detects a passenger on the at least one seat assembly and the indication corresponds to the passenger retention member being in a disengaged condition; and allow the elevator car to move when the detector detects a passenger on the at least one seat assembly and the indication corresponds to the passenger retention member being in an engaged condition for resisting movement of the passenger relative to the at least one seat assembly.

In addition to one or more of the features described above, or as an alternative, the system includes a safety chain and wherein: the indicator includes a switch associated with the safety chain; the indication corresponds to an open or closed position of the switch; the switch is closed when the passenger retention member is engaged to resist movement of the passenger relative to the at least one seat assembly; and the at least one criterion comprises the switch being closed.

In addition to one or more of the features described above, or as an alternative, the system includes a safety chain and wherein: the indicator comprises a switch associated with the safety chain; the indication corresponds to an open or closed position of the switch; the switch is closed when the passenger retention member is engaged to resist movement of the passenger relative to the at least one seat assembly; and the safety chain prevents movement of the elevator car when the detector detects a passenger on the at least one seat assembly and the switch is open.

In addition to one or more of the features described above, or as an alternative, the passenger retention member comprises a strap, a seat belt, or a harness.

In addition to one or more of the features described above, or as an alternative, the detector and indicator are part of a sensing system that detects passenger presence, passenger weight, and a retention member setting of whether the passenger retention member is engaged or disengaged, and including a controller that is configured to selectively control movement of the at least one elevator car, wherein the controller is configured to prevent elevator car movement or initiate elevator car stopping if the passenger retention member is not engaged or is disengaged during movement of the at least one elevator car, initiate a controlled stop with a lower deceleration rate if the passenger retention member is disengaged during movement of the at least one elevator car, and/or estimate a load in-car to control motor operation and/or dispatching decisions.

In addition to one or more of the features described above, or as an alternative, the system includes a plurality of hoistways and wherein the elevator car is configured to move vertically within at least two of the plurality of hoistways, and the elevator car is configured to move horizontally between the at least two of the plurality of hoistways.

In addition to one or more of the features described above, or as an alternative, the system includes at least a first isolation member associated with an upper end of the at least one seat assembly and a second isolation member associated with a lower end of the at least one seat assembly.

In addition to one or more of the features described above, or as an alternative, each seat assembly includes: a seat having a seat back portion and a seat bottom portion; an upper seat member, wherein the first isolation member reacts between the upper seat member and an upper end of the seat; and a lower seat member, wherein the second isolation member reacts between the lower seat member and a lower end of the seat.

In addition to one or more of the features described above, or as an alternative, the upper seat member comprises a hard stop, and wherein the lower seat member includes a sensing system.

In addition to one or more of the features described above, or as an alternative, the first isolation member and the second isolation member comprise a vertical vibration absorption system.

In addition to one or more of the features described above, or as an alternative, the system includes one or more hoistways and wherein: the elevator car is configured to move vertically within at least two hoistways and to move horizontally between the at least two hoistways; or the elevator car is configured to move vertically within one hoistway, and including a shuttle car having at least one car receiver configured to receive the elevator car exiting the one hoistway such that the shuttle car can move the elevator car along a horizontal path.

In addition to one or more of the features described above, or as an alternative, the elevator car is self-propelled.

An illustrative example method comprises a method of controlling at least one elevator car including a floor and a plurality of walls, the at least one elevator car having at least one seat assembly supported on at least one of the plurality of walls or on the floor, and each seat assembly including a passenger retention member that is configured to resist movement of a passenger relative to the at least one seat assembly, the method including: detecting when a passenger is on the at least one seat assembly; and providing an indication regarding a condition of the passenger retention member when a passenger is detected on the at least one seat assembly.

In addition to one or more of the features described above, or as an alternative, the method includes selectively allowing the at least one elevator car to move based on the indication satisfying at least one criterion when a passenger is detected on the at least one seat assembly.

In addition to one or more of the features described above, or as an alternative, a detector and an indicator are part of a sensing system that detects passenger presence, passenger weight, and a retention member setting of whether the passenger retention member is engaged or disengaged, the method including: preventing the elevator car from moving when a passenger is detected on the at least one seat assembly and the indication corresponds to the passenger retention member being in a disengaged condition; allowing the elevator car to move when a passenger is detected on the at least one seat assembly and the indication corresponds to the passenger retention member being in an engaged condition for resisting movement of the passenger relative to the at least one seat assembly; preventing elevator car movement or initiating elevator car stopping if the indication corresponds to the passenger retention member being disengaged prior to movement of the elevator car, or corresponds to the passenger retention member being disengaged during movement of the elevator car; initiating a controlled stop with a lower deceleration rate if the indication corresponds to the passenger retention member being disengaged during movement of the elevator car; and/or estimating a load in-car to control motor operation and/or dispatching decisions.

In addition to one or more of the features described above, or as an alternative, providing the indication regarding the condition of the passenger retention member further comprises: associating a switch with a safety chain, wherein the indication corresponds to an open or closed position of the switch, and the at least one criterion comprises the switch being closed; and closing the switch when the passenger retention member is engaged to resist movement of the passenger relative to the at least one seat assembly.

In addition to one or more of the features described above, or as an alternative, providing the indication regarding the condition of the passenger retention member further comprises: associating a switch with a safety chain, wherein the indication corresponds to an open or closed position of the switch; closing the switch when the passenger retention member is engaged to resist movement of the passenger relative to the at least one seat assembly; and preventing movement of the elevator car via the safety chain when a passenger is detected on the at least one seat assembly and the switch is open.

In addition to one or more of the features described above, or as an alternative, the method includes mounting the at least one seat assembly in a floating relationship on at least one of the plurality of walls and/or the floor.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an exemplary embodiment of an elevator system;

FIG. 2 schematically illustrates another exemplary embodiment of an elevator system;

FIG. 3 schematically illustrates an exemplary embodiment of a seating arrangement in an elevator car;

FIG. 4 schematically illustrates an exemplary embodiment of a seat mounting configuration;

FIG. 5 schematically illustrates another exemplary embodiment of a seat mounting configuration;

FIG. 6 schematically illustrates an exemplary embodiment of a seat absorption system;

FIG. 7 schematically illustrates another exemplary embodiment of a seat absorption system; and

FIG. 8 is a flowchart diagram illustrating an exemplary method of controlling movement of an elevator car.

### DETAILED DESCRIPTION

Embodiments of this disclosure provide isolated mounting of seats to a wall and/or a floor of an elevator car, as well as intelligent data gathering to ensure seat belts are engaged on occupied seats prior to movement. This disclosed arrangement improves passenger comfort by isolating passengers from certain loads due to stopping events and change-in-direction events, for example.

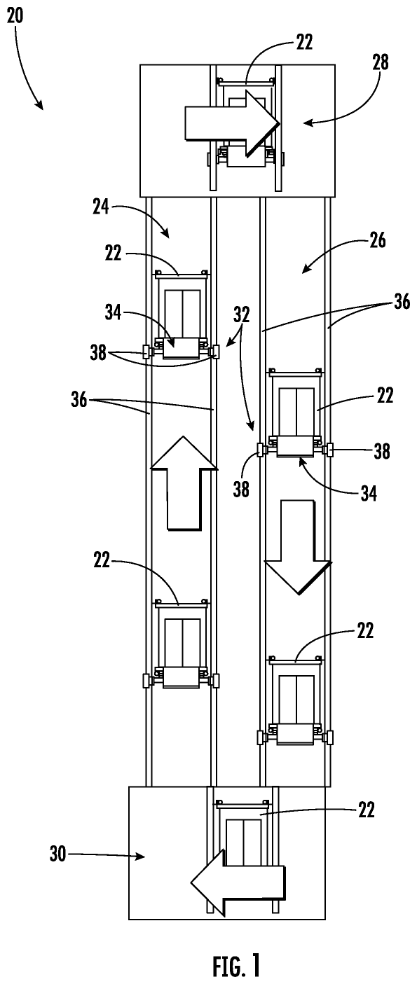

FIG. 1 schematically illustrates selected portions of an elevator system 20 with one or more elevator cars 22 that are self-propelled. In one example, the elevator system 20 includes a first hoistway 24 in which elevators cars 22 travel upward and a second hoistway 26 in which elevators cars 22 travel downward. The elevator system 20 transports elevators cars 22 from a first floor/landing to a top floor/landing in the first hoistway 24, and transports elevators cars 22 from the top floor/landing to the first floor/landing in the second hoistway 26. As known by those skilled in the art, any number of floors/landings can be located between the first floor/landing and the top floor/landing, and the elevator cars 22 may be configured to stop at one or more of these floors/landings.

In one example, above or at the top floor/landing is an upper transfer station 28 to move the elevator cars 22 along a horizontal path from the first hoistway 24 to the second hoistway 26. In one example, below or at the first floor/landing is a lower transfer station 30 to move the elevator cars 22 along a horizontal path from the second hoistway 26 to the first hoistway 24. As known by those skilled in the art, the elevator system 20 may include one or more intermediate transfer stations (not shown) located between the upper 28 and lower 30 transfer stations, and/or may include more than one transfer station at the top or bottom of the elevator system.

In one example, the elevator system 20 includes a propulsion system 32 to move the elevator cars 22 within the hoistways and transfer stations. In one example, the propulsion system 32 comprises a self-propelled configuration where the elevator cars 22 are driven by a power source 34, e.g. an electric drive motor, to move along rails 36 via traction rollers 38. However, as known by those skilled in the art, other types of propulsion systems could also be used.

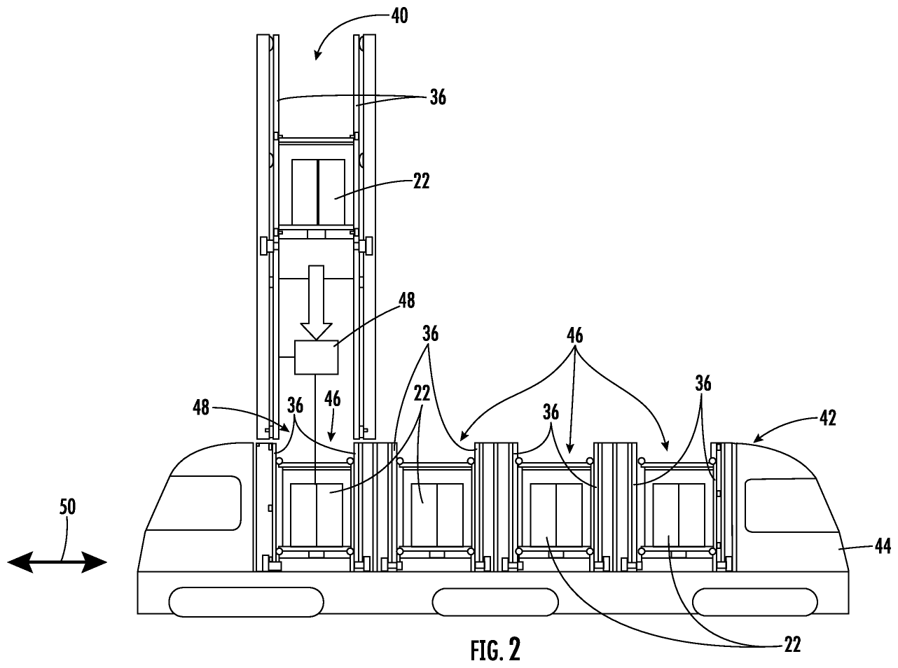

FIG. 2 shows another example system that transfers the elevator car 22 from a hoistway 40 to a horizontal shuttle system 42. In one example, the horizontal shuttle system 42 includes a shuttle car 44 having one or more car receiving stations 46 that are each configured to receive at least one elevator car 22. A vehicle loading device 48, schematically shown in FIG. 2, can be used to transfer the elevator car 22 from the hoistway 40 to the shuttle car 44. Those skilled in the art who have the benefit of this description will be able to determine how to transfer the elevator car 22 from the hoistway 40 to the shuttle car 44.

In this example, the elevator car 22 is configured to move vertically within the hoistway 40, and the shuttle car 44 moves one of the car receiving stations 46 into alignment with the hoistway 40 such that the car receiving station 46 receives the elevator car 22 exiting the hoistway 40. Once the elevator car 22 is docked within the shuttle car 44 in one of the car receiving stations 46, the shuttle car 44 can move the elevator car 22 along a horizontal path in either direction as indicated by arrow 50.

For elevator systems 20 that have both horizontal and vertical movements, such as the recirculating self-propelled system described above, it is important to provide riding passenger comfort by minimizing load transfer to the passenger under various operating scenarios, such as braking, accelerating, direction change, and the like. It is contemplated that such minimization of load transfer will provide for increased passenger comfort. Embodiments of the subject disclosure provides for a seating configuration that requires isolation in both up and down directions and minimizes load transfer.

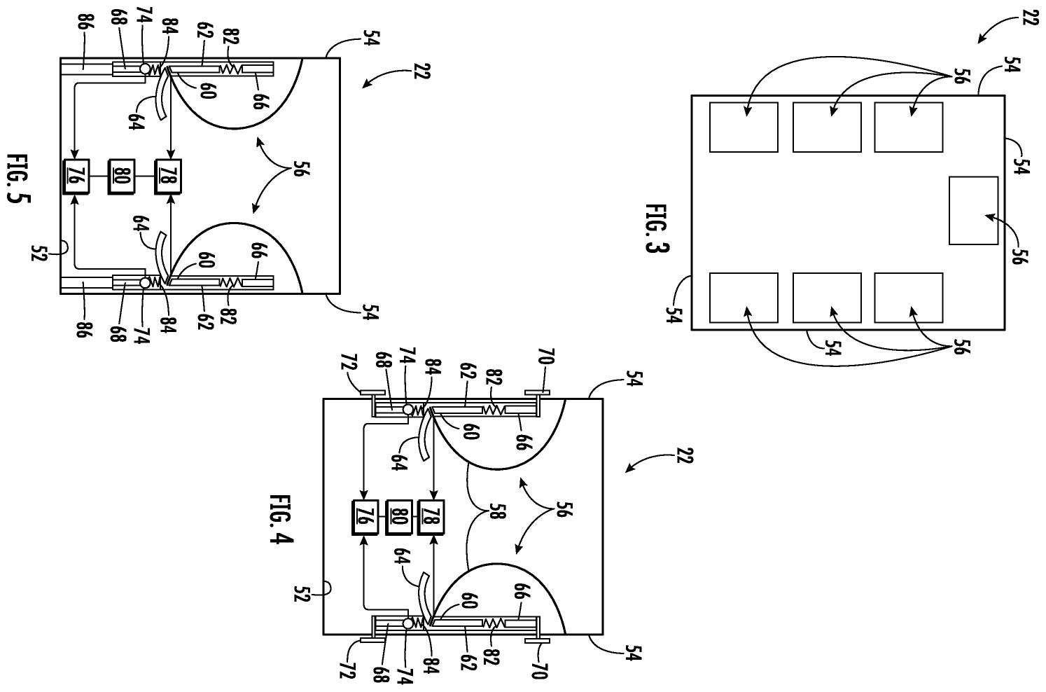

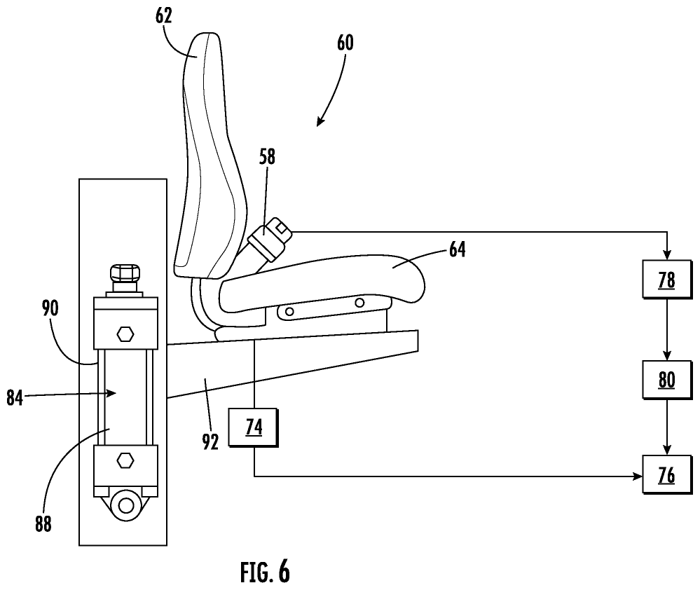

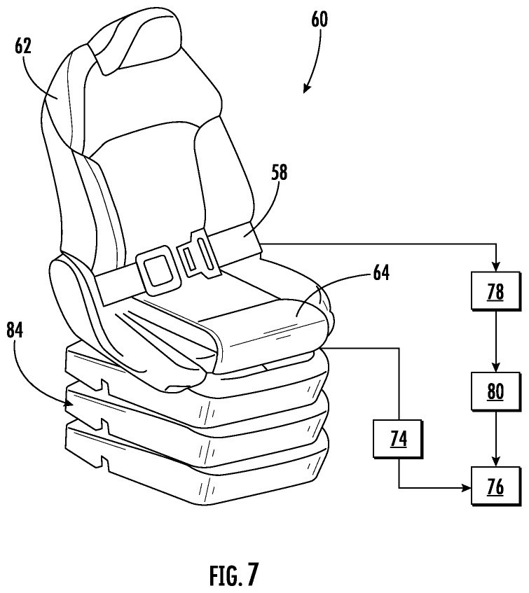

The elevator car 22 includes a floor 52 (FIG. 4) and a plurality of walls 54 (FIG. 3). In one example, the disclosure provides isolated mounting of one or more seat assemblies 56 in a spaced configuration as shown in FIG. 3. The seat assemblies 56 are either mounted to the walls 54 (FIG. 4) or the floor (FIG. 5) in a floating configuration. The seat assemblies 56 could also have attachments to both the wall 54 and the floor such that the wall attachment could provide guidance of the seat for vertical movement, while the floor provides a force reaction surface. The subject disclosure also provides for intelligent data gathering to ensure that passenger retention members 58 are engaged on occupied seats prior to movement of the elevator car 22. The disclosed arrangement isolates passengers from loads that occur during stopping events or direction change events, while also ensuring that passengers are seated and passenger retention members 58 are engaged prior to elevator movement. The passenger retention member 58 is configured to resist movement of a passenger relative to the associated seat assembly 56. The passenger retention member 58, for example, is a strap that comprises a seat belt or a harness (see FIGS. 6-7).

FIG. 3 shows one example configuration where three seat assemblies 56 are on each of the side walls of the elevator car 22 and one seat assembly 56 is on a rear wall of the elevator car 22, leaving a forward or front wall free of seats at a door location. However, as known by those skilled in the art, other seating arrangements within an elevator car 22 could also be provided dependent on the size of the car, the size of the seats, the number of elevator doors, etc. For example, one seat assembly 56 may be provided on a side wall or floor of the elevator car 22.

FIG. 4 shows an example where the seat assemblies 56 are mounted to one or more walls 54 of the elevator car 22. In one example, each seat assembly 56 includes a seat 60 having a seat back portion 62 and a seat bottom portion 64, an upper seat member 66, and a lower seat member 68. In one example, the upper seat member 66 comprises an upper hard stop that is fixed to the wall 54 with a bracket 70, and the lower seat member 68 comprises a lower hard stop that is fixed to the wall 54 with a bracket 72. In one example, the lower seat member 68 also includes a sensing system or a detector 74. In one example, the sensing system or detector 74 comprises a seat load sensor or video hardware components to provide video analytics.

The elevator system 20 includes at least one controller 76 that is configured to determine when a seat 60 is occupied, to determine if the passenger retention member 58 is engaged or disengaged, and to control movement of the elevator car 22 by controlling the propulsion system 32. In one example, an indicator 78 is used to provide a status indication of the passenger retention member 58, which is then communicated to the controller 76. The controller 76 in the illustrated example includes a computing device and associated memory. The controller 76 is programmed or otherwise configured to receive data and/or other information indicative of seat occupation and passenger retention member status to determine whether or not the elevator car 22 should be allowed to move within an associated hoistway or transfer station.

In one example configuration, the detector 74 is configured to detect when a passenger is seated on the seat assembly 56, and the indicator 78 is configured to provide an indication regarding a condition of the passenger retention member 58 when the detector 74 detects a passenger on the associated seat assembly 56. In one example, the detector 74, e.g. a seat load sensor, senses the weight of a passenger on the seat 60 and an input signal with this information is sent to the controller 76. In one example, the indicator 78 associated with the passenger retention member 58 is at least operationally linked to a safety chain 80. As known by those skilled in the art, the safety chain 80 is a series connection of door lock switches that indicate whether the hoistway doors are all locked. If any door is not properly closed and locked, the corresponding switch is open, interrupting the chain, and the car cannot move. In the disclosed exemplary elevator system 20, the passenger retention member 58 has the indicator 78, which in one example comprises a switch that is associated with the safety chain 80. Optionally, the switch indicator 78 could directly provide an input to the controller 76 that is treated the same as an indication from the safety chain 80 so that the elevator car 22 can only move when the passenger retention member 58 of any seat occupied by a passenger is engaged.

In one example, the controller 76 of the elevator system 20 is configured to selectively allow the elevator car 22 to move based on the indication of the indicator 78 satisfying at least one criterion. The at least one criterion may be satisfied after the detector 74 detects a passenger on the associated seat assembly 56. In one example, the controller 76 is configured to prevent the elevator car 22 from moving when the detector 74 detects a passenger on the seat assembly 56 and the indication of the indicator 78 corresponds to the passenger retention member 58 being in a disengaged condition. In one example, the controller 76 is configured to allow the elevator car 22 to move when the detector 74 detects a passenger on the seat assembly 56 and the indication of the indicator 78 corresponds to the passenger retention member 58 being in an engaged condition for resisting movement of the passenger relative to the seat assembly 56.

As discussed above, in one example, the indicator 78 comprises a switch that is associated with the safety chain 80. The indication of the indicator 78 corresponds to an open position or closed position of the switch. The switch is closed when the passenger retention member 58 is engaged to resist movement of the passenger relative to the seat assembly 56. The controller 76 allows the elevator car 22 to move when the indication of the indicator 78 satisfies the criterion of the switch being closed when the detector 74 detects a passenger on the associated seat assembly 56. The controller 76 prevents the elevator car 22 from moving when the detector 74 detects a passenger on the seat assembly 56 and the indication of the indicator 78 does not satisfy the criterion, meaning that the switch is open.

In one example, the sensing system or detector 74 could be used to determine a combination of three states: passenger presence, passenger weight, and retention device setting, e.g. engaged or disengaged. This information is communicated to the controller 76 and analyzed by the controller 76 to determine a control action. Such control actions can include: preventing vertical or lateral motion, stop motions in any direction, altering of motion response, preventing car movement or initiating car stopping if the passenger retention member is not engaged or is opened during movement of the car, initiating a controlled stop with a lower deceleration rate if retention member opening is detected, reducing speed, stopping at the nearest floor, etc. In addition, the sensing system or detector 74 could provide an estimate of a load in-car to improve motor pre-torquing to reduce roll back, and to give an indication of passengers in-car to improve dispatching decisions. Those skilled in the art who have the benefit of this description will be able to determine how to provide an estimate of a load in-car by using a load-weighing system, for example.

In one example, to further improve passenger comfort, at least a first isolation member 82 is associated with an upper end of the seat assembly 56 and a second isolation member 84 associated with a lower end of the seat assembly 56 as shown in FIG. 4. The first isolation 82 member reacts between the upper seat member 66 and an upper end of the seat 60, and the second isolation member 84 reacts between the lower seat member 68 and a lower end of the seat 60. In one example, the isolation members comprise resilient members, dampers, springs, shocks, or other similar structures. By putting isolation members, such as resilient members on the upper and lower ends of the seat 60, the seat 60 is in a floating mount configuration on the wall 54 such that passengers sitting on the seat 60 are isolated from vibrations or load transfers during elevator travel.

FIG. 5 is similar to FIG. 4, but shows the seat assemblies 56 mounted to the floor 52 of the elevator car 22 with a vertical support member 86. In this example, the seat 60 is in a floating mount configuration on the floor 52 such that passengers sitting on the seat 60 are isolated from load transfers during elevator travel.

FIG. 6 shows one example of the isolation member 84 comprising a vertical vibration absorption system associated with the lower end of the seat 60. In this example, the isolation member 84 comprises a damper or shock absorber having a an internal member 88 that is moveable back and forth along a vertical direction within a housing 90. One of the internal member 88 and housing 90 is mounted to the elevator wall 54 or floor 52 and the other of the internal member 88 and housing 90 is mounted to a platform 92 associated with the seat bottom portion 64. Those skilled in the art who have the benefit of this description will be able to determine how to mount the internal member 88 and housing 90.

FIG. 7 shows another example of the isolation member 84 comprising a vertical vibration absorption system associated with the lower end of the seat 60. In this example, the isolation member 84 comprises plurality of compressible members 94 positioned underneath the seat bottom portion 64. The compressible members 94 are stacked on top of each other and compress/expand to absorb loads in the vertical direction. Those skilled in the art who have the benefit of this description will be able to determine how to mount and arrange the compressible members 94.

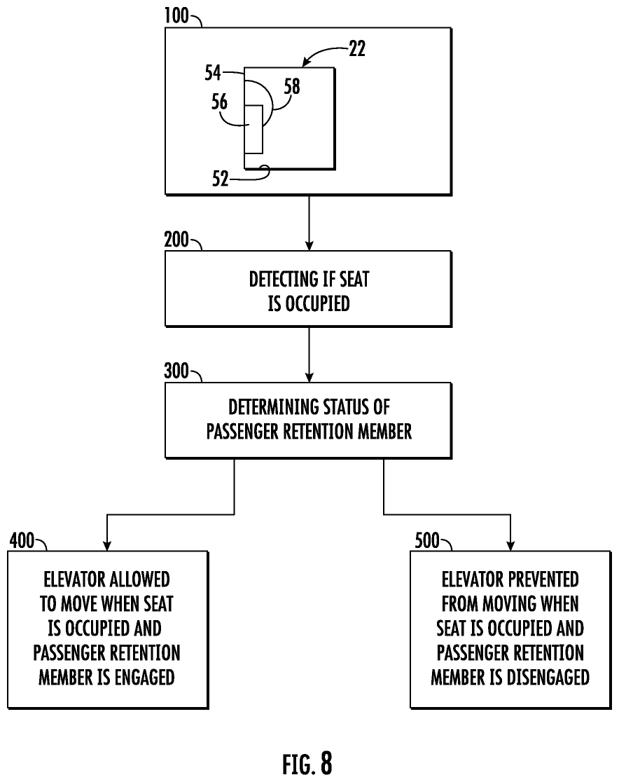

FIG. 8 shows a flowchart illustrating the method of controlling movement of at least one elevator car 22. As indicated at 100, the elevator car 22 includes a floor 52 and a plurality of walls 54, and further includes at least one seat assembly 56 supported on the wall 54 or floor 52, with each seat assembly 56 including a passenger retention member 58.

As indicated at 200, the method includes detecting when a passenger is on the seat assembly 56.

As indicated at 300, the method includes providing an indication regarding a condition of the passenger retention member 58 when a passenger is detected on the seat assembly 56.

As indicated at 400, the method includes selectively allowing the elevator car 22 to move based on the indication satisfying at least one criterion when a passenger is detected on the seat assembly 56 where the at least one criterion comprises the passenger retention member 58 being engaged.

As indicated at 500, the method includes preventing the elevator car 22 from moving when a passenger is detected on the seat assembly 56 and the passenger retention member 58 is not engaged.

Several embodiments are illustrated in the drawings and described above. The features of the individual embodiments are not necessarily limited to those examples. Other embodiments are possible that combine at least one feature of one of the example embodiments with at least one feature of another example embodiment. In other words, additional embodiments having a combination of features from separately illustrated embodiments are within the scope of this disclosure.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator system, comprising:
at least one elevator car including a floor and a plurality of walls;
at least one seat assembly supported on at least one of the plurality of walls or on the floor;
a detector configured to detect when a passenger is on the at least one seat assembly;
a passenger retention member that is configured to resist movement of a passenger relative to the at least one seat assembly; and
an indicator configured to provide an indication regarding a condition of the passenger retention member when the detector detects a passenger on the at least one seat assembly.

2. The elevator system of claim 1, further comprising a controller,
wherein the controller is configured to selectively allow the at least one elevator car to move when the detector detects a passenger on the at least one seat assembly.

3. The elevator system of claim 2, wherein the controller is further configured to prevent the elevator car from moving when the detector detects a passenger on the at least one seat assembly and the indication corresponds to the passenger retention member being in a disengaged condition; and
allow the elevator car to move when the detector detects a passenger on the at least one seat assembly and the indication corresponds to the passenger retention member being in an engaged condition for resisting movement of the passenger relative to the at least one seat assembly.

4. The elevator system of claim 2, further comprising:
a safety chain, and wherein:
the indicator includes a switch associated with the safety chain;
the indication corresponds to an open or closed position of the switch;
the switch is closed when the passenger retention member is engaged to resist movement of the passenger relative to the at least one seat assembly; and
the at least one criterion comprises the switch being closed.

5. The elevator system of claim 1, further comprising:
a safety chain, and wherein:
the indicator comprises a switch associated with the safety chain;
the indication corresponds to an open or closed position of the switch;
the switch is closed when the passenger retention member is engaged to resist movement of the passenger relative to the at least one seat assembly; and
the safety chain prevents movement of the elevator car when the detector detects a passenger on the at least one seat assembly and the switch is open.

6. The elevator system of claim 1, wherein the passenger retention member comprises a strap, a seat belt, or a harness.

7. The elevator system of claim 1, wherein the detector and indicator are part of a sensing system configured to detect passenger presence, passenger weight, and a retention member setting of whether the passenger retention member is engaged or disengaged, and the sensing system includes a controller that is configured to selectively control movement of the at least one elevator car, wherein the controller is configured to perform at least one of the following:
prevent elevator car movement or initiate elevator car stopping if the passenger retention member is not engaged or is disengaged during movement of the at least one elevator car,
initiate a controlled stop with a lower deceleration rate if the passenger retention member is disengaged during movement of the at least one elevator car, and
estimate a load in-car to control motor operation and/or dispatching decisions.

8. The elevator system of claim 1, further comprising:
a plurality of hoistways, and wherein
the elevator car is configured to move vertically within at least two hoistways of the plurality of hoistways; and
the elevator car is configured to move horizontally between the at least two hoistways of the plurality of hoistways.

9. The elevator system of claim 1, further comprising:
a first isolation member associated with an upper end of the at least one seat assembly; and
a second isolation member associated with a lower end of the at least one seat assembly.

10. The elevator system of claim 9, wherein each seat assembly includes:
a seat having a seat back portion and a seat bottom portion;
an upper seat member, wherein the first isolation member reacts between the upper seat member and an upper end of the seat; and
a lower seat member, wherein the second isolation member reacts between the lower seat member and a lower end of the seat.

11. The elevator system of claim 10, wherein the upper seat member comprises a hard stop, and wherein the lower seat member includes a sensing system.

12. The elevator system of claim 9, wherein the first isolation member and the second isolation member comprise a vertical vibration absorption system.

13. The elevator system of claim 9, further comprising:
a plurality of hoistways, and wherein:
the elevator car is configured to move vertically within at least two hoistways of the plurality of hoistways and to move horizontally between the at least two hoistways of the plurality of hoistways; or
the elevator car is configured to move vertically within one hoistway of the plurality of hoistways, and the elevator system further comprises a shuttle car having at least one car receiver configured to receive the elevator car exiting the one hoistway such that the shuttle car can move the elevator car along a horizontal path.

14. The elevator system of claim 1, wherein the elevator car is self-propelled.

15. A method of controlling at least one elevator car including a floor and a plurality of walls, the at least one elevator car having at least one seat assembly supported on at least one of the plurality of walls or on the floor, and each seat assembly including a passenger retention member that is configured to resist movement of a passenger relative to the at least one seat assembly, the method including:
detecting when a passenger is on the at least one seat assembly; and
providing an indication regarding a condition of the passenger retention member when a passenger is detected on the at least one seat assembly.

16. The method of claim 15, further comprising:
selectively allowing the at least one elevator car to move based on the indication satisfying at least one criterion when a passenger is detected on the at least one seat assembly.

17. The method of claim 16, wherein a detector and an indicator are part of a sensing system that detects passenger presence, passenger weight, and a retention member setting of whether the passenger retention member is engaged or disengaged, and the method further includes:
preventing the elevator car from moving when a passenger is detected on the at least one seat assembly and the indication corresponds to the passenger retention member being in a disengaged condition;
allowing the elevator car to move when a passenger is detected on the at least one seat assembly and the indication corresponds to the passenger retention member being in an engaged condition for resisting movement of the passenger relative to the at least one seat assembly;
preventing elevator car movement or initiating elevator car stopping if the indication corresponds to the passenger retention member being disengaged prior to movement of the elevator car, or corresponds to the passenger retention member being disengaged during movement of the elevator car;
initiating a controlled stop with a lower deceleration rate if the indication corresponds to the passenger retention member being disengaged during movement of the elevator car; and/or
estimating a load in-car to control motor operation and/or dispatching decisions.

18. The method of claim 16, wherein providing the indication regarding the condition of the passenger retention member further comprises:
associating a switch with a safety chain, wherein the indication corresponds to an open or closed position of the switch, and the at least one criterion comprises the switch being closed; and
closing the switch when the passenger retention member is engaged to resist movement of the passenger relative to the at least one seat assembly.

19. The method of claim 15, wherein providing the indication regarding the condition of the passenger retention member further comprises:
associating a switch with a safety chain, wherein the indication corresponds to an open or closed position of the switch;
closing the switch when the passenger retention member is engaged to resist movement of the passenger relative to the at least one seat assembly; and
preventing movement of the elevator car via the safety chain when a passenger is detected on the at least one seat assembly and the switch is open.

20. The method of claim 15, further comprising:
mounting the at least one seat assembly in a floating relationship on at least one of the plurality of walls and/or the floor.
